(19) United States
(12) Patent Application Publication
(10) Pub. No.: US 2025/0304128 A1
(43) Pub. Date: Oct. 2, 2025

(54) Unsupervised Learning-based Fault Diagnosis Method and System for Detecting Wheel Out of Round in Rail Transit

(71) Applicant: BEIJING JIAOTONG UNIVERSITY, Beijing (CN)

(72) Inventors: Hong XIAO, Beijing (CN); Guangsheng CHEN, Beijing (CN); Liang GAO, Beijing (CN); Yang WANG, Beijing (CN); Zhihai ZHANG, Xi'an (CN); Yihao CHI, Beijing (CN); Shaolei WEI, Beijing (CN); Zhongxia QIAN, Beijing (CN); Yawen ZHANG, Beijing (CN); Chang XIAO, Beijing (CN); Yiqing WANG, Beijing (CN); Guangming SHI, Beijing (CN); Shuwei FANG, Beijing (CN); Qiang LIU, Tianjin (CN); Yuze CAO, Tianjin (CN)

(73) Assignee: BEIJING JIAOTONG UNIVERSITY, Beijing (CN)

(21) Appl. No.: 18/901,018

(22) Filed: Sep. 30, 2024

(30) Foreign Application Priority Data
Apr. 1, 2024 (CN) 2024103870931

(51) Int. Cl. B61L 27/57; G01B 17/06; G01M 17/10

(52) U.S. Cl. CPC B61L 27/57; G01B 17/06; G01M 17/10

(57) ABSTRACT

The invention provides the unsupervised learning-based fault diagnosis method and system for detecting wheel out of round, which belongs to the technical field of machine learning fault diagnosis. Characteristic signals of train wheels will be acquired. The pre-trained detection model is adopted to process the characteristic signals of the train wheels to be detected, so as to obtain the wheel roundness state results. As for the collected characteristic signals, the invention constructs a subway wheel out of round detection method based on unsupervised learning for collected characteristic signals, which are deployed to computer equipment capable of executing computer programs, inputting characteristic signal data collected by a subway wheel out of round monitoring device based on rail wayside response into the computer equipment to obtain the wheel roundness state.

### CROSS-REFERENCE TO RELATED APPLICATIONS

This application claims priority to Chinese Patent Application Ser. No. CN2024103870931 filed on 1 Apr. 2024.

### TECHNICAL FIELD

The invention relates to the technical field of machine learning fault diagnosis, in particular to an unsupervised learning-based fault diagnosis method and system for detecting wheel out of round.

### TECHNICAL BACKGROUND

With the continuous improvement of the operation speed and mileage of urban rail transit, train wheels not rounded has become increasingly serious. The appearance of train wheel out of round will cause a series of problems, such as the surge of the wheel-rail force, the generation of the abnormal vibration and noise, the shortened service life of track structure and vehicle parts. At present, wheel rotary repair is still the most economical and effective means to control wheel out of round. However, because subway vehicles mainly adopt the maintenance mode of preventive planned maintenance combined with fault maintenance, it is easy to give rise to problems such as wheel under-rotation repair and wheel over-rotation repair. Moreover, the economic benefit of vehicle maintenance is minimal, and the quality and level of subway train operation service cannot be further improved. How to detect and identify the wheel out of round quickly and efficiently and realize the transformation from “repair based on plan” to “repair based on condition” of wheel rotation repair is of great significance to the high-quality and sustainable development of rail transit.

In addition to the traditional static detection method using wheel circumference roughometer, the existing research on wheel out-of-round detection and identification technology is mainly divided into two directions: vehicle-mounted detection methods and rail wayside detection methods. At present, there are many intelligent recognition methods for wheel polygons. However, most intelligent identification methods mainly focus on vehicle-mounted detection method, that is, the identification of wheel polygons is realized by the labeled vibration response signals of wheelsets, axle boxes and frames, which has the limitations of complicated layout and low efficiency in field application. At the same time, most of the data signals that reflect the wheel roundness in engineering practice are non-linear and non-stationary unlabeled data with low signal-to-noise ratios.

### SUMMARY OF INVENTION

The invention aims to provide a unsupervised learning-based fault diagnosis method and system for detecting wheel out of round, which can fully utilize massive unlabeled data to identify key information such as the characteristic wavelength and wave depth amplitude of wheel polygon, and realize the detection of subway wheel out of round in a high-precision and high-efficiency way, so as to solve at least one technical problem existing in the above background technology.

In order to achieve the above purposes, the invention makes use of the following technical scheme:

Firstly, the invention provides a method for diagnosing wheel out-of-round fault based on unsupervised learning, which comprises the following steps:
(1) Acquiring the characteristic signals of train wheels to be detected.
(2) Processing the obtained characteristic signals of train wheel to be detected by employing a pre-trained detection model, the result of the wheel roundness state is obtained, in which the training of the detection model comprises the following steps: (1) acquiring the characteristic signals when each wheel of each train passes through a monitoring section, and obtaining the time domain information of sensitive source according to the characteristic signals; (2) carrying out data cleaning and screening on the time domain information of the sensitive source, getting a fault identification component representing the wheel out of round damage, and constructing a component database of wheel out of round fault identification; (3) building an unsupervised feature extraction model of the wheel out of round fault identification component in line with the datasets of the wheel out of round fault identification component, and then training them to obtain the high-dimensional abstract features of the fault signal; (4) According to the high-dimensional abstract characteristics of the fault signal, a fault identification algorithm of wheel out of round is constructed based on fuzzy clustering algorithm, obtaining the optimal clustering result by iterative updating; (5) And the specific wheel roundness state is finally determined by selecting one or several data from each cluster of the optimal clustering results, and the data is analyzed through empirical knowledge.

Optionally, the time domain information of sensitive sources is subjected to data cleaning and screening, specifically including:

Preprocessing that time domain information of each segmented sensitive source, other noise interference is eliminated by band-pass filtering, and the data sample length is uniformly set. The ensemble empirical mode decomposition is performed on the filtered and denoised time series vector to obtain IMF components and residual components of each order of the characteristic signal:

$$x ( t ) = {\sum }_{i = 1}^{n} {c}_{i} ( t ) + {r}_{n} ( t )$$

Where, x(t) is the time series vector after filtering and noise reduction, cᵢ(t) is the natural modal component of each order, and rₙ(t) is the residual component.

Alternatively, the signal correlation analysis method is used to calculate the correlation between IMF components of each order and the original characteristic signal, so as to extract the components containing more wheel fault information; The larger the correlation coefficient, the stronger the correlation between them. The calculation formula of signal cross-correlation coefficient is:

$${ρ}_{( Rr )} = \frac{{\sum }_{x = 0}^{+ ∞} R ( x ) \cdot r ( x )}{\sqrt{{\sum }_{x = 0}^{+ ∞} {R}^{2} ( x ) \cdot {\sum }_{x = 0}^{+ ∞} {r}^{2} ( x )}}$$

Where ρ_{(Rr)} is the correlation coefficient, r(x) is the IMF component signal of each order, and R(x) is the original characteristic signal.

When calculating the cross-correlation coefficient between IMF components of each order and the original characteristic signal, the IMF component with the largest calculation result of correlation coefficient is selected as the wheel polygon fault identification component to construct the wheel polygon fault identification component database.

Optionally, the unsupervised feature extraction model of wheel out of round fault identification component is composed of stacked sparse autoencoder. The stacked sparse autoencoder, by minimizing the reconstruction error under the sparsity limitation, can automatically learn the effective data representation from unlabeled wheel out of round fault identification component data and extract the high-dimensional abstract features of fault signals.

Optionally, the wheel out of round fault identification algorithm based on the fuzzy clustering algorithm comprises the following steps: the high-dimensional abstract features, obtained from the unsupervised feature extraction model of the wheel polygon fault identification component, is taken as the input of the Gath-Geva clustering algorithm for clustering operation, performing algorithm updating training. Among them, the constructed Gath-Geva clustering algorithm is verified by adopting clustering effect evaluation indexes including but not limited to classifier coefficient and average fuzzy entropy in the algorithm updating training, so as to find the optimal clustering number of the algorithm through repeated experiments.

Optionally, searching the optimal clustering number of the algorithm includes:

$${V}_{pc} = \frac{1}{n} {{\sum }_{j = 1}}^{n} {{\sum }^{K}}_{i = 1} {u}_{ij}^{2} \\ {V}_{ce} = - \frac{1}{n} {{\sum }^{n}}_{j = 1} {{\sum }_{i = 1}}^{κ} {u}_{ij} ln {u}_{ij}$$

Where, V_{pc}∈[0,1] is the index of classifier coefficient, V_{ce}∈[0,1] is the average index of fuzzy entropy, uᵢⱼ indicates that the membership degree of the j^{th} sample data belongs to class i, n represents the total number of sample data in the sample set, and K is the number of clustering centers. The closer the index of V_{pc} is to 1, the closer that of V_{ce} is to 0, indicating that when the similarity between samples in the same cluster is high, and the similarity between samples in different clusters is low, the clustering effect is better.

Secondly, the invention provides a unsupervised learning-based fault diagnosis system for detecting wheel out of round, including:
(1) The acquisition module is used for getting the characteristic signals of the train wheels to be detected.
(2) The processing module takes the use of processing the acquired characteristic signals of the train wheels to be detected by the pre-trained detection model to obtain the wheel roundness state result. The training of the detection model comprises the following steps: (1) Achievement is made on characteristic signals when each wheel of each train passes through a monitoring section, which is conducive to acquiring the time domain information of sensitive sources; (2) Data cleaning and screening is carried out on the time domain information of the sensitive source to obtain the fault identification component representing the wheel out-of-round damage, so that the wheel out of round fault identification component database is constructed; (3) According to the wheel out of round fault identification component datasets, construction is implemented on unsupervised feature extraction model of the wheel out of round fault identification component, then trained to obtain a high-dimensional abstract feature of the fault signal;
(4) Depending on the high-dimensional abstract characteristics of the fault signal, a wheel polygon fault identification algorithm based on fuzzy clustering algorithm is constructed, and the optimal clustering result is obtained by iterative updating;
(5) One or several data from each cluster of the optimal clustering results is equably selected, analyzed by empirical knowledge, and finally determining the specific wheel roundness state.

Thirdly, the invention provides a non-transient computer-readable storage medium for storing computer instructions which realize the wheel out-of-round fault diagnosis method based on the unsupervised learning mentioned in the first aspect when executed by a processor.

Fourthly, the invention offers a computer device, including a memory and a processor, wherein the processor and the memory communicate with each other. The memory stores the program instructions executable by the processor, and the processor gives the program instructions to execute the unsupervised learning-based fault diagnosis method for detecting wheel out-of-round.

Fifthly, the invention provides an electronic device which comprises a processor, a memory and a computer program. Wherein, the processor is connected with the memory, and the computer program is stored in the memory. When the electronic device runs, the processor executes the computer program stored in the memory, so that the electronic device executes the instructions for realizing the unsupervised learning-based fault diagnosis method for detecting wheel out-of-round.

The method has the beneficial effect that a subway wheel out of round detection method based on unsupervised learning is constructed for the collected characteristic signals, which is deployed to computer equipment capable of processing computer programs, inputting the characteristic signal data collected by the subway wheel polygon monitoring device based on rail wayside response into the computer equipment to obtain the wheel roundness state. Compared with the existing intelligent detection method of wheel polygon, it can accurately identify the position, order and amplitude of wheel polygon at the same time, and it also can be arranged in different track structure types and different track line forms, without affecting the daily operation of urban rail transit and with the advantages of high efficiency, accuracy and saving operating costs, which is conducive to promoting the transformation of subway operation departments from “repair based on plan” to “repair based on wheel condition”, maximizing the economic benefits of wheel rotation repair and helping the green development of rail transit.

The additional advantages of the invention will be listed as follows, and may be learned by users in the application of the invention.

### BRIEF DESCRIPTION OF DRAWINGS

In order to explain the technical scheme of the invention embodiment more clearly, the drawings needed in the description of the embodiment will be briefly introduced below. Obviously, the drawings in the following description are only some embodiments of the invention. For ordinary people in the field, other drawings can be obtained according to these drawings without creative work.

FIG. 1 is a polygonal schematic diagram of a subway wheel according to an embodiment of the invention.

FIG. 2 is a flowchart of the method for detecting the polygon of subway wheels based on unsupervised learning according to an embodiment of the invention.

FIG. 3 is a structural diagram of constructing a polygon detection model for subway wheels based on unsupervised learning according to an embodiment of the invention.

FIG. 4 is a flow chart of the fuzzy clustering algorithm.

FIG. 5 is a schematic diagram of subway rail vibration test according to an embodiment of the invention.

FIG. 6 is a vertical vibration acceleration signal of a rail when certain wheel of a train passes by according to an embodiment of the invention.

FIG. 7 is a flowchart of a polygon monitoring framework for subway wheels based on unsupervised learning according to an embodiment of the invention.

FIG. 8 is a diagram of a polygon monitoring device for subway wheels based on unsupervised learning according to an embodiment of the invention.

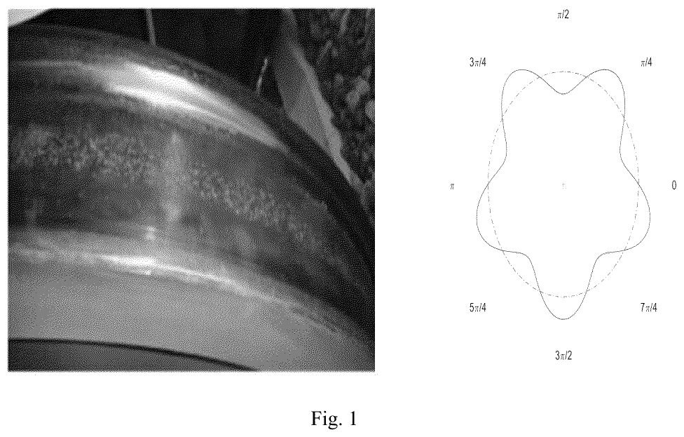

### DETAILED DESCRIPTION OF INVENTION

Hereinafter, implements of the invention will be described in detail, examples of which are illustrated in the accompanying drawings, wherein the same or similar labels indicate the same or similar elements or elements with the same or similar functions throughout. The embodiments described below through the drawings are exemplary, only for explaining the invention, but cannot be interpreted as limiting the invention.

It can be understood by those skilled in the art that, unless otherwise defined, all terms (including technical terms and scientific terms) used herein have the same meaning as commonly understood by those skilled in the art to which this invention belongs.

It should be further understood that terms such as those defined in general dictionaries should be got across to have meanings consistent with those in the context of the prior art, and will not be interpreted in an idealized or overly formal sense unless defined as such.

It can be understood by those skilled in the art that the singular forms “a”, “an”, “the” and “this” used herein can also include plural forms unless specifically stated. It should be further understood that the word “comprising” used in the specification of the invention refers to the presence of the mentioned feature, integer, step, operation, element and/or component, but does not exclude the presence or addition of one or more other features, integers, steps, operations, elements and/or components thereof.

In the description of this specification, descriptions referring to the terms “one embodiment”, “some embodiments”, “examples”, “specific examples” or “some examples” mean that specific features, structures, materials or characteristics, described in connection with this embodiment or example, are included in at least one embodiment or example of the invention. Moreover, the specific features, structures, materials or characteristics described may be combined in any one or more embodiments or examples in a suitable manner. In addition, those skilled in the art can combine and combine different embodiments or examples and features of different embodiments or examples described in this specification without contradicting each other.

Moreover, the specific features, structures, materials or characteristics described may be combined in any one or more embodiments or examples in a suitable manner. In addition, those skilled in the art can combine and constitute different embodiments or examples and features of different embodiments or examples described in this specification without contradicting each other.

For easy understanding, the specific examples are used to further explain the invention in conjunction with the drawings, which do not constitute the limitations of the invention embodiments.

It should be understood by those skilled in the art that the drawings are only schematic diagrams of embodiments, and the components in the drawings may be not necessary for implementing the invention.

### Embodiment 1

In Embodiment 1, firstly, a unsupervised learning-based fault diagnosis system for detecting wheel out of round is provided, which comprises an acquisition module for acquiring the train wheel characteristic signal to be detected; a processing module for processing the acquired characteristic signals of the train wheels to be detected by using the pre-trained detection model to obtain the wheel roundness state result. The training of the detection model includes the following steps: (1) acquiring characteristic signals when all wheel of each train passes through a monitoring section, on basis of which the time domain information of sensitive sources is obtained; (2) carrying out data cleaning and screening on the time domain information of the sensitive source to obtain a fault identification component representing the wheel out-of-round damage, so that a wheel polygon fault identification component database is built; (3) In line with the wheel polygon fault identification component data set, the unsupervised feature extraction model of the wheel polygon fault identification component is constructed and trained, so as to obtain the high-dimensional abstract feature of the fault signal; (4) Depending on the high-dimensional abstract characteristics of the fault signal, the wheel polygon fault identification algorithm is set up based on fuzzy clustering algorithm, getting the optimal clustering result by iterative updating; (5) One or several data from each cluster of the optimal clustering results is selected, then analyzed by empirical knowledge, finally determining the specific roundness state of the wheel.

In Embodiment 1, according to the above-mentioned system, achievement is made on the unsupervised learning-based fault diagnosis method for detecting wheel out of round, which comprises an acquisition module for acquiring the train wheel characteristic signal to be detected; a processing module for processing the acquired characteristic signals of the train wheels to be detected by using the pre-trained detection model to obtain the wheel roundness state result. The training of the detection model includes the following steps: acquiring characteristic signals when each wheel of each train passes through a monitoring section, on basis of which the time domain information of sensitive sources is obtained; carrying out data cleaning and screening on the time domain information of the sensitive source to obtain a fault identification component representing the wheel out-of-round damage, so that a wheel polygon fault identification component database is built; constructing and training the unsupervised feature extraction model of the wheel polygon fault identification component in line with the wheel polygon fault identification component data set, so as to obtain the high-dimensional abstract feature of the fault signal; setting up the wheel polygon fault identification algorithm based on fuzzy clustering algorithm depending on the high-dimensional abstract characteristics of the fault signal, getting the optimal clustering result by iterative updating; selecting one or several data from each cluster of the optimal clustering results, then analyzing by empirical knowledge, finally determining the specific roundness state of the wheel.

Cleaning and screening the time domain information of sensitive sources, specifically includes:

Pretreatment is made on the time domain information of each segmented sensitive source, to eliminate other noise interference by band-pass filtering, uniformly setting the data sample length. The ensemble empirical mode decomposition is performed on the filtered and denoised time series vector to obtain IMF components and residual components of the characteristic signal at each grading:

$$x ( t ) = {\sum }_{i = 1}^{n} {c}_{i} ( t ) + {r}_{n} ( t )$$

Where, x(t) is the time series vector after filtering and noise reduction, cᵢ(t) is the natural modal component of each order, and rₙ(t) is the residual component.

The signal correlation analysis method is used to calculate the correlation between IMF component at each order and the original characteristic signal, so as to extract the component containing more wheel fault information. The larger the correlation coefficient, the stronger the correlation between them. The calculation formula of signal cross-correlation coefficient is:

$${ρ}_{( Rr )} = \frac{{\sum }_{x = 0}^{+ ∞} R ( x ) \cdot r ( x )}{\sqrt{{\sum }_{x = 0}^{+ ∞} {R}^{2} ( x ) \cdot {\sum }_{x = 0}^{+ ∞} {r}^{2} ( x )}}$$

Where ρ_{(Rr)} is the correlation coefficient, r(x) is the IMF component signal of each order, and R(x) is the original vibration signal.

The cross-correlation coefficient between IMF components of each order and the original rail vibration signal is calculated, and the IMF component with the largest correlation coefficient calculation result is selected as the wheel polygon fault identification component, so that the wheel polygon fault identification component database is constructed.

The unsupervised feature extraction model for detecting wheel out of round fault identification is composed of stacked sparse autoencoder. Stacked sparse autoencoder can automatically learn the effective data representation from unlabeled wheel polygon fault identification component data by minimizing the reconstruction error under the sparsity limitation, extracting the high-dimensional abstract features of fault signals.

The wheel polygon fault identification algorithm based on the fuzzy clustering algorithm comprises the following steps: the high-dimensional abstract features, obtained from the unsupervised feature extraction model of the wheel polygon fault identification component, is taken as the input of the Gath-Geva clustering algorithm for clustering operation, and performing algorithm updating training. Among them, the constructed Gath-Geva clustering algorithm is verified by evaluation indexes including but not limited to classification coefficient and average fuzzy entropy clustering effect in the algorithm updating training, finding the optimal clustering number of the algorithm through repeated experiments.

Finding the optimal clustering number of the algorithm includes:

$${V}_{pc} = \frac{1}{n} {{\sum }_{j = 1}}^{n} {{\sum }^{K}}_{i = 1} {u}_{ij}^{2} \\ {V}_{ce} = - \frac{1}{n} {{\sum }^{n}}_{j = 1} {{\sum }_{i = 1}}^{κ} {u}_{ij} ln {u}_{ij}$$

Where, V_{pc}∈[0,1] is the index of classification coefficient, V_{ce}∈[0,1] is the index of average fuzzy entropy, uₒₖ indicates the membership degree of the j^{th} sample data belongs to class i, n represents the total number of sample data in the sample set, and K is the number of clustering centers. The closer the index of V_{pc} is to 1, the closer that of V_{ce} is to 0, indicating that the similarity between samples in the same cluster is high, meanwhile, similarity between samples in different clusters is high, and the clustering effect is better.

### Embodiment 2

In Embodiment 2, firstly, a monitoring device of subway wheel polygon based on rail wayside vibration response is provided, which supports the detection method of subway wheel polygon based on unsupervised learning, including: the sensor unit, used for acquiring unsteady characteristic signals generated by the passing of different urban rail transit vehicles, the acquisition unit, used for collecting characteristic signal to obtain the time domain information of sensitive sources, the data transmission unit, uploading the obtained time domain information of sensitive source to a remote client by wireless transmission; the data cleaning and screening unit, used for carrying out digital filtering and noise reduction on the time domain information of sensitive sources to extract fault identification components which can effectively represent the damage of wheel out of round, the wheel polygon detection unit, disposing the subway wheel polygon detection method based on unsupervised learning on the device to detect the input characteristic signal data and obtain the wheel roundness state, and the visualization unit, printing the identified wheel roundness status (wheel position, wheel polygon order and wheel polygon amplitude) on the remote client.

In this embodiment, the method for detecting the subway wheels polygon based on unsupervised learning is realized by using the above device and the framework, including: The characteristic signals of each wheel of each train passing through the monitoring section are obtained by installing sensors and monitoring equipment in the subway field test section, and the time domain information of sensitive sources is obtained according to the characteristic signals. Data cleaning and screening on the time domain information of the sensitive source is carried out to obtain the fault identification component which can effectively represent the wheel out-of-round damage, so that the wheel polygon fault identification component database is constructed. The unsupervised feature extraction model of the wheel polygon fault identification component is built according to the wheel polygon fault identification component data set, and then trained to obtain high-dimensional abstract features of the fault signal. According to the high-dimensional abstract characteristics of the fault signal, the wheel polygon fault identification algorithm based on fuzzy clustering algorithm is set up, obtaining the optimal clustering result by iterative updating. One or several data from each cluster of the optimal clustering results is selected, analyzed by professional experience and knowledge, and finally determining the specific wheel roundness state. The characteristic signal data to be detected is input into the detection method of subway wheels polygon based on unsupervised learning, getting the wheel roundness state.

The above technical scheme takes into account that there are significant differences in time-frequency characteristics of characteristic signals generated when normal wheels and non-circular wheels of urban rail transit vehicles that pass through the monitoring section. Similarly, the time-frequency characteristics of characteristic signals caused by different orders and amplitudes are obviously different for faulty wheels. In addition, in most practical engineering application scenarios, the obtained data signals are mostly non-linear and non-stationary unlabeled data with low signal-to-noise ratio. It is time-consuming and laborious to manually label a large number of unlabeled data with low cost performance and poor accuracy. Therefore, in the invention, the feature signal caused by the wheel polygon is subjected to ensemble empirical mode decomposition and signal correlation analysis so as to obtain the wheel polygon fault identification component, and the fault identification component is input into the stacked sparse autoencoder to extract the high-dimensional abstract features of the fault signal, so that the wheel polygon fault identification algorithm is constructed based on the fuzzy clustering algorithm, and accurate identification of the wheel roundness state can be realized with the help of professional experience knowledge.

Compared with the existing intelligent identification methods of wheel polygons, the method of the embodiment can quickly and efficiently realize the accurate identification of the order and amplitude of wheel polygon by inputting the collected feature signals into the subway wheel polygon detection method based on unsupervised learning. At the same time, the invention has no need to carry out inefficient and tedious labeling work on massive unlabeled data, thus greatly reducing the fault diagnosis workload of personnel.

The data cleaning and screening of sensitive source time domain information specifically includes:
Pretreatment is carried out on the time domain information of sensitive sources to eliminate other noise interference by band-pass filtering, uniformly setting the data sample length. Ensemble empirical mode decomposition is performed on the filtered and denoised time series vectors to obtain IMF components and residual components of sensitive sources time domain information;

$$x ( t ) = {\sum }_{i = 1}^{n} {c}_{i} ( t ) + {r}_{n} ( t )$$

Where, x(t) is the time series vector after filtering and noise reduction, cᵢ(t) is the natural modal component of each order, and rₙ(t) is the residual component.

In order to extract the components containing more wheel fault information, the signal correlation analysis method is adopted to calculate the correlation between IMF components of each order and the original characteristic signal. The larger the correlation coefficient, the stronger the correlation between them. The calculation formula of signal cross-correlation coefficient is:

$${ρ}_{( Rr )} = \frac{{\sum }_{x = 0}^{+ ∞} R ( x ) \cdot r ( x )}{\sqrt{{\sum }_{x = 0}^{+ ∞} {R}^{2} ( x ) \cdot {\sum }_{x = 0}^{+ ∞} {r}^{2} ( x )}}$$

Where ρ_{(Rn)} is the correlation coefficient, r(x) is the IMF component signal of each order, and R(x) is the original vibration signal.

The cross-correlation coefficient between IMF components of each order and the original characteristic signal is calculated, and the IMF component with the largest calculation result of correlation coefficient is selected as the wheel polygon fault identification component, so that the wheel polygon fault identification component database is constructed.

The unsupervised feature extraction model of wheel polygon fault identification component is composed of stacked sparse autoencoder. Stacked sparse autoencoder can automatically learn the effective data representation from unlabeled wheel polygon fault identification component data by minimizing the reconstruction error under the sparsity limitation, thus extracting the high-dimensional abstract features of fault signals and helping the subsequent fuzzy clustering algorithm model achieve better performance more quickly.

The wheel polygon fault identification algorithm based on fuzzy clustering algorithm includes:

The high-dimensional abstract features, obtained by the unsupervised feature extraction model of the wheel polygon fault identification component, is taken as the input of the Gath-Geva clustering algorithm for clustering operation, performing algorithm updating training.

Among them, the Gath-Geva clustering algorithm is verified by evaluation indexes including but not limited to classification coefficient and average fuzzy entropy clustering effect in the algorithm updating training, finding the optimal clustering number of the algorithm through repeated experiments.

$${V}_{pc} = \frac{1}{n} {{\sum }_{j = 1}}^{n} {{\sum }^{K}}_{i = 1} {u}_{ij}^{2} \\ {V}_{ce} = - \frac{1}{n} {{\sum }^{n}}_{j = 1} {{\sum }_{i = 1}}^{κ} {u}_{ij} ln {u}_{ij}$$

Where, V_{pc}∈[0,1] is the index of classification coefficient, V_{ce}∈[0,1] is the index of average fuzzy entropy, V_{ce}∈[0,1] indicates the membership degree of the j^{th} sample data belongs to class i, n represents the total number of sample data in the sample set, and K is the number of clustering centers. The closer the index of V_{pc} is to 1, the closer that of V_{pc} is to 0, indicating that the similarity between samples in the same cluster is high; meanwhile, the similarity between samples in different clusters is high, the clustering effect is better.

### Embodiment 3

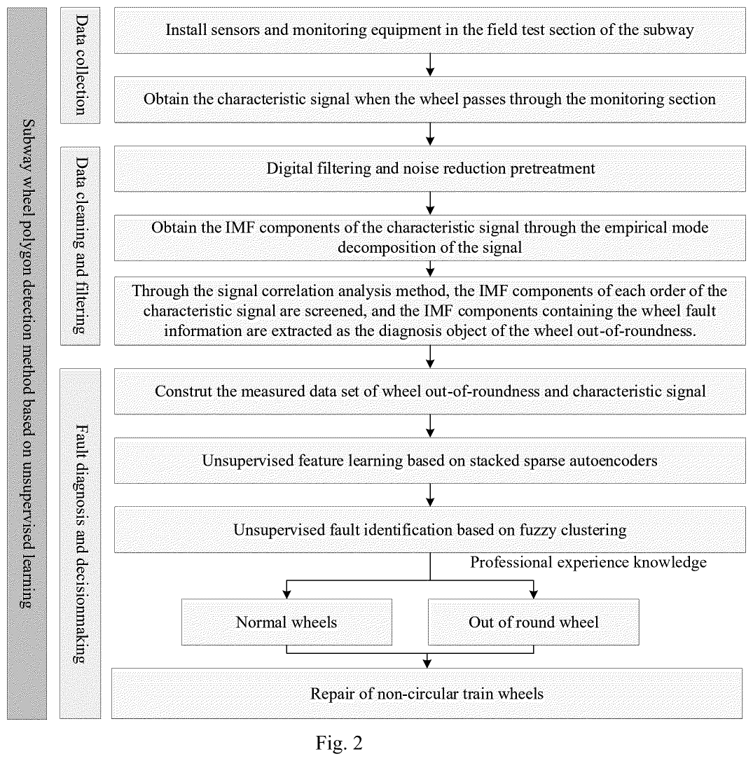

As shown in FIG. 2, the method for detecting the subway wheels polygon based on unsupervised learning is provided in Embodiment 3, which includes:

By installing vibration sensors and monitoring equipment in the subway field test section, the acceleration signal of rail vibration is obtained when all wheels of each train pass through the monitoring section, on basis of which the time domain information of rail vibration is acquired;

Data cleaning and screening is carried out on the time domain information of rail vibration to obtain a fault identification component which can effectively represent the wheel out-of-round damage, constructing a wheel polygon fault identification component database;

An unsupervised feature extraction model of the wheel polygon fault identification component is constructed according to the wheel polygon fault identification component datasets, and then trained to obtain high-dimensional abstract features of the fault signal.

Depending on the high-dimensional abstract characteristics of the fault signal, a wheel polygon fault identification algorithm based on fuzzy clustering algorithm is constructed, and the optimal clustering result is obtained by iterative updating.

One or several data from each cluster of the optimal clustering results is selected, analyzed by using professional experience and knowledge, and finally determining the specific wheel roundness state.

The vibration acceleration data of the rail to be detected is input into the detection method of subway wheel polygon based on unsupervised learning so as to get the wheel roundness state.

In this embodiment, the data cleaning and screening of rail vibration time domain information specifically includes:

Pretreatment is carried out on vibration spatial domain information of each segment to eliminate other noise interference by band-pass filter, and uniformly setting the data sample length. The filtered and denoised time series vector is decomposed by ensemble empirical mode to obtain the IMF components of each order and residual components of rail vibration acceleration:

$$x ( t ) = {\sum }_{i = 1}^{n} {c}_{i} ( t ) + {r}_{n} ( t )$$

Where, x(t) is the time series vector after filtering and noise reduction, cᵢ(t) is the natural modal component of each order, and rₙ(t) is the residual component.

In order to extract the components containing more wheel fault information, the signal correlation analysis method is used to calculate the correlation between IMF components of each order and the original vibration signal. The larger the correlation coefficient, the stronger the correlation between them. The calculation formula of signal cross-correlation coefficient is:

$${ρ}_{( Rr )} = \frac{{\sum }_{x = 0}^{+ ∞} R ( x ) \cdot r ( x )}{\sqrt{{\sum }_{x = 0}^{+ ∞} {R}^{2} ( x ) \cdot {\sum }_{x = 0}^{+ ∞} {r}^{2} ( x )}}$$

Where, ρ_{(Rr)} is the correlation coefficient, r(x) is the IMF component signal of each order, and R(x) is the original vibration signal.

When calculating the cross-correlation coefficient between IMF components of each order and the original rail vibration signal, the IMF component with the largest correlation coefficient calculation result is selected as the wheel polygon fault identification component, so as to construct the wheel polygon fault identification component database.

In this Embodiment, the unsupervised feature extraction model of wheel polygon fault identification component is composed of stacked sparse autoencoder. stacked sparse autoencoder can automatically learn the effective data representation from unlabeled wheel polygon fault identification component data by minimizing the reconstruction error under the sparsity limitation, thus extracting the high-dimensional abstract features of fault signals and helping the subsequent fuzzy clustering algorithm model achieve better performance more quickly.

In this Embodiment, the wheel polygon fault identification algorithm based on fuzzy clustering algorithm includes:
The high-dimensional abstract features, obtained by the unsupervised feature extraction model of the wheel polygon fault identification component, is taken as the input of the Gath-Geva clustering algorithm for clustering operation, then algorithm updating training is performed;
Among them, the Gath-Geva clustering algorithm is verified by evaluation indexes including but not limited to classification coefficient and average fuzzy entropy clustering effect in the algorithm updating training, to find the optimal clustering number of the algorithm through repeated experiments.

$${V}_{pc} = \frac{1}{n} {{\sum }_{j = 1}}^{n} {{\sum }^{K}}_{i = 1} {u}_{ij}^{2} \\ {V}_{ce} = - \frac{1}{n} {{\sum }^{n}}_{j = 1} {{\sum }_{i = 1}}^{κ} {u}_{ij} ln {u}_{ij}$$

Where, V_{pc}∈[0,1] is the index of classification coefficient, V_{ce}∈[0,1] is the index of average fuzzy entropy, uᵢⱼ indicates the membership degree of the j^{th} sample data belongs to class i, n represents the total number of sample data in the sample set, and K is the number of clustering centers. The closer the index of V_{pc} is to 1, the closer that of V_{ce} is to 0, indicating that the similarity between samples in the same cluster is high;

meanwhile, the similarity between samples in different clusters is high, and the clustering effect is better.

The working principle is that this embodiment takes into account that there are significant differences in time-frequency characteristics of rail vibration signals generated when normal wheels and non-circular wheels of urban rail transit vehicles pass through the monitoring section. Similarly, the time-frequency characteristics of rail vibration signals caused by different orders and amplitudes are obviously different for faulty wheels. In addition, in most practical engineering application scenarios, the obtained data signals are mostly non-linear, non-stationary unlabeled data with low signal-to-noise ratio. It is time-consuming and laborious to manually label a large number of unlabeled data in the way of low cost-effective and low accuracy. Therefore, in the invention, the rail vibration signals caused by the wheel polygon are subjected to ensemble empirical mode decomposition and signal correlation analysis to obtain the wheel polygon fault identification component, and the fault identification component is input to the stacked sparse autoencoder to extract the high-dimensional abstract features of the fault signal, so as to construct the wheel polygon fault identification algorithm based on the fuzzy clustering algorithm, and to achieve the accurate identification of the wheel roundness state with the help of professional experience knowledge.

According to this method, the accurate identification of wheel polygon characteristic order and amplitude can be realized quickly and efficiently by inputting the collected rail vibration acceleration signal into the detection method of subway wheel polygon based on unsupervised learning. At the same time, in the application of the invention, there is no need to carry out inefficient and tedious labeling work on massive unlabeled data, thus greatly reducing the fault diagnosis workload of personnel.

### Embodiment 4

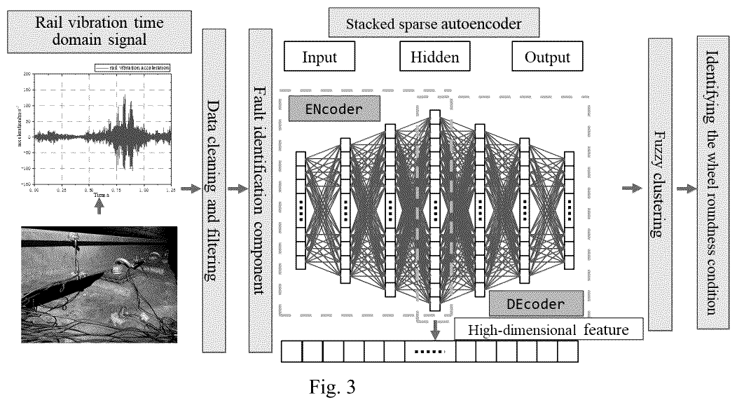

As shown in FIG. 3, the difference between this embodiment and embodiment 3 is that this embodiment is in line with the subway wheel polygon detection method based on the unsupervised learning in Embodiment 1, which is implemented as follows:

The method comprises the following steps: 1) Rail vibration signals are measured when different wheels of different trains pass by to obtain the vibration time domain information; 2) Data cleaning and screening is carried out on the vibration time domain information to obtain fault identification components which can effectively represent the damage of wheel out of round, so that the polygon fault identification component database of the wheel is constructed; 3) The unsupervised feature extraction model of the wheel polygon fault identification component is constructed, and trained to obtain the high-dimensional abstract features of the fault signal; 4) The wheel polygon fault identification algorithm based on fuzzy clustering algorithm is built, to obtain the optimal clustering result by iterative updating; 5) One or several data from each cluster of the optimal clustering result is selected, analyzed by using professional experience and knowledge, and finally determining the specific wheel roundness state; 6) The vibration acceleration data of the rail to be detected is input into the subway wheel polygon detection method based on unsupervised learning to obtain the wheel roundness state.

The equipment adopted by the method comprises:
An acceleration sensor, which is arranged at the middle rail of two adjacent sleepers and used for measuring rail vibration signals;
The data acquisition module, which is connected with the acceleration sensor and used for collecting vibration signals and obtaining the vibration time domain information;
The data processing module, which is connected with the data acquisition module and used for processing the data collected by the data acquisition module into the format which can be utilized for recognizing the wheel polygon state by computers;

Examples of implementation methods are given below.

### (1) Data Description

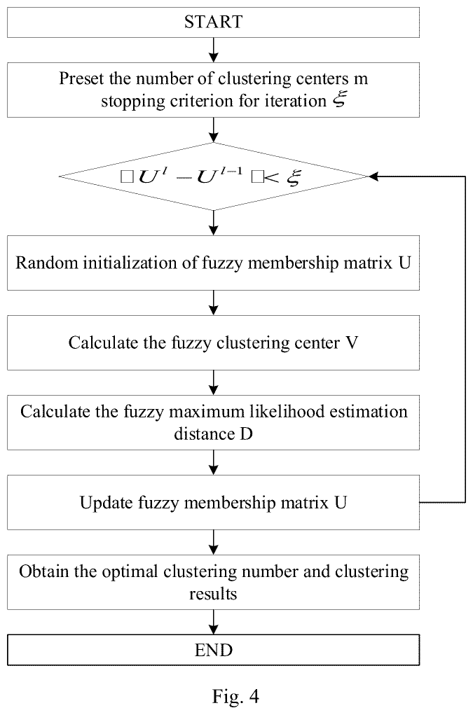

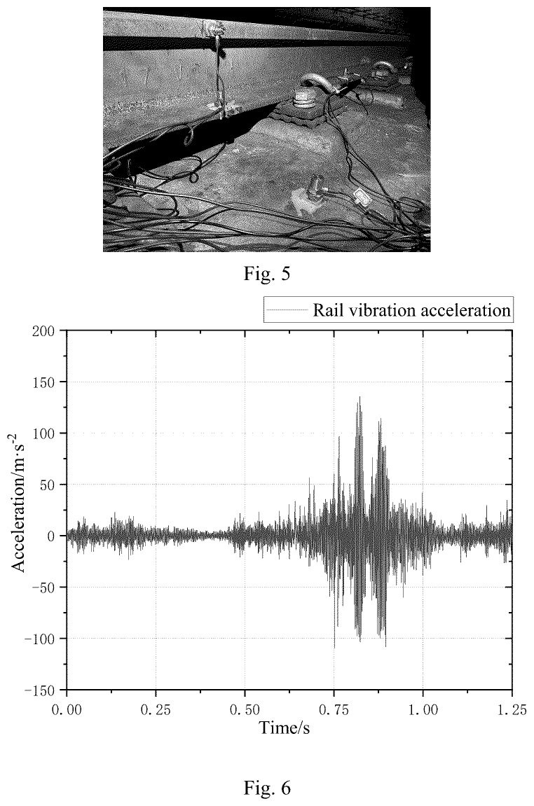

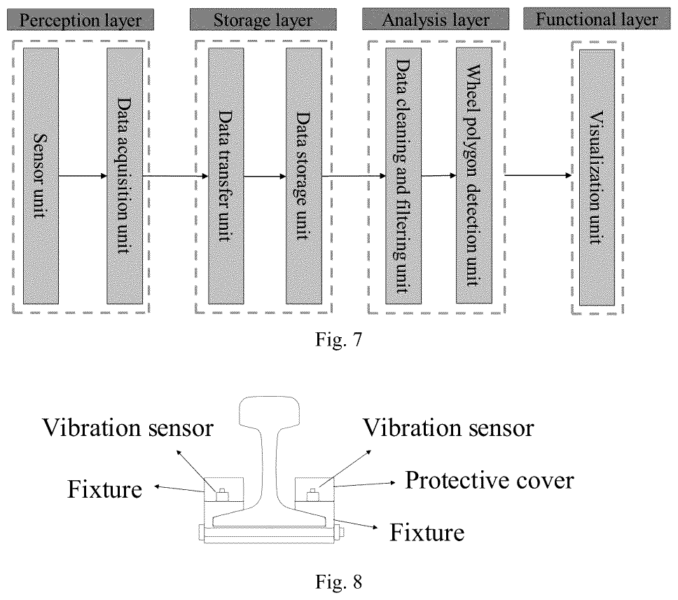

Carrying out a field test on a certain section of a subway line in a Chinese city, the vertical vibration acceleration signals of a rail when a wheel of a train passes are obtained by using the multi-channel 24AD high-precision data acquisition system of Dongfang Institute, as shown in FIG. 4 and FIG. 5.

### (2) Data Cleaning and Screening

Data cleaning and screening is implemented on the vibration time domain information to obtain the fault identification component which can effectively represent the damage of wheel out of round, so that the wheel polygon fault identification component database is constructed.

### (3) Feature Extraction

The datasets of wheel polygon fault identification component are input into an unsupervised feature extraction model of the wheel polygon fault identification component, and then the model is trained to obtain high-dimensional abstract features of the fault signals.

### (4) Fault Identification

The high-dimensional abstract features of the fault signal is input into the wheel polygon fault identification algorithm based on fuzzy clustering algorithm, so as to obtain the optimal clustering result by iterative updating;

### (6) Determination of Wheel Roundness

One or several data from each cluster of the optimal clustering results is selected, analyzed by professional experience and knowledge, and finally determining the specific wheel roundness state.

### (7) Detection of Subway Wheel Polygon Based on Unsupervised Learning.

The vibration acceleration data of the rail to be detected is input into the detection method of subway wheel polygon based on unsupervised learning to obtain the wheel roundness state.

### Embodiment 5

Embodiment 5 provides a non-transient computer-readable storage medium for storing computer instructions. When computer instructions are executed by a processor, achievement is made on the above-mentioned wheel out-of-round fault diagnosis method based on unsupervised learning.

### Embodiment 6

Embodiment 6 provides a computer device, including a memory and a processor, which communicate with each other. The memory stores program instructions that can be executed by the processor, and the processor calls the program instructions to execute the fault diagnosis method of wheel out of round based on unsupervised learning as described above.

### Embodiment 7

Embodiment 7 provides an electronic device, including a processor, a memory and a computer program; Wherein, the processor is connected with the memory, and the computer program is stored in the memory. When the electronic device runs, the processor executes the computer program stored in the memory, so that the electronic device implements the instructions for realizing the fault diagnosis method of wheel out of round based on unsupervised learning.

It should be understood by those skilled in the art that embodiments of the invention can be provided as methods, systems, or computer program products. As a result, the invention can take the form of an entirely hardware embodiment, an entirely software embodiment, or an embodiment combining software and hardware aspects. Furthermore, the invention can take the form of a computer program product embodied on one or more computer-usable storage media (including but not limited to disk storage, CD-ROM, optical storage, etc.) containing computer-usable program codes therein.

The invention is described with reference to the flowcharts and/or the block diagrams of methods, devices (systems) and computer program products according to its embodiments. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, special-purpose computer, embedded processor or processor of other programmable data processing equipment to produce a machine, so that the instructions, which are executed by the processor of the computer or other programmable data processing equipment, produce the device for implementing the specified functions of a flow or flows in the flowchart and/or a block or blocks in the block diagram.

These computer program instructions may also be stored in a computer-readable memory that can direct a computer or other programmable data processing equipment to function in a particular manner, so that the instructions stored in the computer-readable memory produce an article of manufacture including instruction device that implement the specified functions of a flow or flows in the flowcharts and/or a block or blocks in the diagrams.

These computer program instructions can also be loaded on a computer or other programmable data processing equipment, and a series of operation steps are performed on the computer or other programmable equipment to produce computer-implemented processes, so that the instructions executed on the computer or other programmable equipment provide steps for implementing the specified functions of a flow or flows in the flowcharts and/or a block or blocks in the block diagrams.

Although the specific embodiment of the invention has been described with the drawings, it is not a limitation on the protection scope of the invention. It should be understood by those skilled in the art that various modifications or deformations, that can be made by those skilled in the art without creative labor on the basis of the technical scheme disclosed in the invention, should be included in the protection scope of the invention.

What is claimed is:

1. A unsupervised learning-based fault diagnosis method for detecting wheel out of round, is characterized in that:
characteristic signals of train wheels will be acquired; the obtained characteristic signals of train wheels to be detected is processed by using a pre-trained detection model to obtain the result of wheel roundness state; the training of the detection model comprises the following steps:
i) acquiring characteristic signals when each wheel of each train passes through a monitoring section, and obtaining the time domain information of the sensitive sources according to the characteristic signals;
ii) data cleaning and screening is carried out on the time domain information of the sensitive source to obtain the fault identification component representing wheel out-of-round, so that the wheel out of round fault identification component database is constructed;
iii) according to the wheel out of round fault identification component dataset, the unsupervised feature extraction model of the wheel out of round fault identification component is constructed, and then trained to obtain the high-dimensional abstract feature of the fault signal;
iv) on the basis of the high-dimensional abstract characteristics of the fault signal, the wheel out of round fault identification algorithm based on fuzzy clustering algorithm is constructed, obtaining the optimal clustering result by iterative updating;
v) one or several data from each cluster of the optimal clustering results is selected, analyzed the data by using empirical knowledge, and finally determining the specific wheel roundness state.

2. The fault diagnosis method of wheel out of round based unsupervised learning according to claim 1, is characterized in that the time domain information of sensitive sources is subjected to data cleaning and screening, specifically comprising:
the time domain information of each segmented sensitive source is preprocessed to eliminate other noise interference by band-pass filtering, uniformly setting the data sample length. The ensemble empirical mode decomposition is performed on the filtered and denoised time series vector to obtain IMF components of each order and residual components of the characteristic signal:
$$x ( t ) = {\sum }_{i = 1}^{n} {c}_{i} ( t ) + {r}_{n} ( t )$$
where, x(t) is the time series vector after filtering and noise reduction, cᵢ(t) is the natural modal component of each order, and rₙ(t) is the residual component.

3. The fault diagnosis method of wheel out of round based on unsupervised learning according to claim 2, is characterized in that the signal correlation analysis method is used to calculate the correlation between IMF components of each order and the original characteristic signal so as to extract the components containing more wheel fault information; the larger the correlation coefficient, the stronger the correlation between them; the calculation formula of signal cross-correlation coefficient is:
$${ρ}_{( Rr )} = \frac{{\sum }_{x = 0}^{+ ∞} R ( x ) \cdot r ( x )}{\sqrt{{\sum }_{x = 0}^{+ ∞} {R}^{2} ( x ) \cdot {\sum }_{x = 0}^{+ ∞} {r}^{2} ( x )}}$$
where ρ₍ₚᵣ₎ is the correlation coefficient, r(x) is the IMF component signal of each order, and R(x) is the original vibration signal;
when calculating the cross-correlation coefficient between IMF components of each order and the original rail vibration signal, the IMF component with the largest correlation coefficient calculation result is selected as the wheel out of round fault identification component, so that the wheel out of round fault identification component database is constructed.

4. The fault diagnosis method of wheel out of round based on unsupervised learning according to claim 1, is characterized in that the unsupervised feature extraction model of the wheel out of round fault identification is composed of stacked sparse autoencoders. Stacked sparse autoencoder can automatically learn the effective data representation from unlabeled wheel out of round fault identification component data by minimizing the reconstruction error under the sparsity limitation, extracting the high-dimensional abstract features of fault signals.

5. The fault diagnosis method of wheel out of round based on unsupervised learning according to claim 1, is characterized in that the wheel out of round fault identification algorithm based on fuzzy clustering algorithm comprises: the high-dimensional abstract features, obtained by the unsupervised feature extraction model of the wheel out of round fault identification component, is taken as the input of Gath-Geva clustering algorithm for clustering operation, and performed algorithm updating training; wherein, the constructed Gath-Geva clustering algorithm is verified by evaluation indexes including but not limited to classification coefficient and average fuzzy entropy clustering effect in the algorithm updating training, finding the optimal clustering number of the algorithm through repeated experiments.

6. The fault diagnosis method of wheel out of round based on unsupervised learning according to claim 5, is characterized in finding the optimal clustering number of the algorithm, which comprises:
$${V}_{pc} = \frac{1}{n} {{\sum }_{j = 1}}^{n} {{\sum }^{K}}_{i = 1} {u}_{ij}^{2} \\ {V}_{ce} = - \frac{1}{n} {{\sum }^{n}}_{j = 1} {{\sum }_{i = 1}}^{κ} {u}_{ij} ln {u}_{ij}$$
where, V_{pc}∈[0,1] is the index of classification coefficient, V_{ce}∈[0,1] is the index of average fuzzy entropy, uᵢⱼ indicates the membership degree of the j^{th} sample data belongs to class i, n represents the total number of sample data in the sample set, K is the number of clustering centers; the closer the index of V_{pc} is to 1, the closer that of V_{ce} is to 0, indicating that the similarity between samples in the same cluster is high, meanwhile the similarity between samples in different clusters is high, and the clustering effect is better.

7. A unsupervised learning-based fault diagnosis system for detecting wheel out of round, is characterized in that comprises:
the acquisition module, is used for acquiring the characteristic signals of the train wheels to be detected;
the processing module, is used for processing the acquired characteristic signals of the train wheels to be detected by utilizing the pre-trained detection model to obtain the wheel roundness state result. The training of the detection model includes the following steps:
(i) the characteristic signals is acquired when each wheel of each train passes through a monitoring section, obtaining the time domain information of sensitive sources according to the characteristic signals;
(ii) data cleaning and screening is carried on the time domain information of the sensitive source to obtain the fault identification component representing the wheel out-of-round damage, so that the wheel out of round fault identification component database is constructed;
(iii) according to the wheel out of round fault identification component data set, the unsupervised feature extraction model of the wheel out of round fault identification component is constructed, and then trained to obtain the high-dimensional abstract feature of the fault signal;
(iv) on the basis of the high-dimensional abstract characteristics of the fault signal, the wheel out of round fault identification algorithm based on fuzzy clustering algorithm is constructed, so as to obtain the optimal clustering result by iterative updating; and
(v) one or several data is selected from each cluster of the optimal clustering results, analyzed by empirical knowledge, and finally determining the specific wheel roundness state.

8. An electronic device is characterized in that includes: a processor, a memory and a computer program; wherein, the processor is connected with the memory, and the computer program is stored in the memory; when the electronic equipment runs, the processor executes the computer program stored in the memory, so that the electronic equipment executes the instructions for realizing the unsupervised learning-based fault diagnosis method for detecting wheel out of round according to claim 1.
